(19) United States
(12) Patent Application Publication
(10) Pub. No.: US 2006/0068128 A1
(43) Pub. Date: Mar. 30, 2006

(54) Optical films and process for making them

(75) Inventors: Jehuda Greener, Rochester, NY (US); Charles C. Anderson, Penfield, NY (US); Marcus S. Bermel, Pittsford, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/954,330

(22) Filed: Sep. 30, 2004

(51) Int. Cl. C09K 19/00

(52) U.S. Cl. 428/1.1

(57) ABSTRACT

A method of film fabrication is taught that uses a coating and drying apparatus to fabricate resin films suitable for optical applications. In particular, resin films are prepared by simultaneous application of multiple liquid layers to a moving carrier substrate having low surface energy. After solvent removal, the resin films are peeled from the sacrificial carrier substrate. Films prepared by the current invention exhibit good dimensional stability and low out-of-plane retardation.

### FIELD OF THE INVENTION

This invention relates generally to methods for manufacturing resin films and, more particularly, to an improved method for the manufacture of optical films used to form electrode substrates, light polarizers, compensation plates, and protective covers in optical devices such as liquid crystal displays and other electronic displays where the films exhibit good dimensional stability and both low in-plane and low out-of-plane retardation.

### BACKGROUND OF THE INVENTION

Transparent resin films are used in a variety of optical applications. In particular, resin films are used as protective cover sheets for light polarizers, compensation films and as electrode substrates in variety of electronic displays. In this regard, optical films are intended to replace glass to produce lightweight, flexible display screens. These display screens include liquid crystal displays, OLED (organic light emitting diode) displays, and other electronic displays found in, for example, personal computers, televisions, cell phones, and instrument panels.

Electronic display screens such as liquid crystal displays (LCD's) contain a number of optical elements that may be formed from resin films. The structure of reflective LCD's may include a liquid crystal cell, one or more polarizer plates, and one or more compensation films. Liquid crystals cells are formed by dispersing twisted nematic (TN) or super twisted nematic (STN) materials between two electrode substrates. For liquid crystals cells, resin substrates have been suggested as lightweight and flexible alternatives to glass substrates. Like glass, resin electrode substrates must be transparent, exhibit very low birefringence, and withstand the high temperatures required to vapor deposit a transparent conductive material, such as indium-tin oxide, onto the surface of the film. Suitable thermally stable resins suggested for electrode substrates include polycarbonates, sulfones, cyclic olefins, and polyarylates.

Polarizer plates are typically a multi-layer element of resin films and are comprised of a polarizing film sandwiched between two protective cover sheets. Polarizing films are normally prepared from a transparent and highly uniform amorphous resin film that is subsequently stretched to orient the polymer molecules and stained with a dye to produce a dichroic film. An example of a suitable resin for the formation of polarizer films is fully hydrolyzed polyvinyl alcohol (PVA). Because the stretched PVA films used to form polarizers are very fragile and dimensionally unstable, protective cover sheets are normally laminated to both sides of the PVA film to offer both support and abrasion resistance. Protective cover sheets of polarizer plates are required to have high uniformity, good dimensional and chemical stability, and high transparency. Originally, protective coversheets were formed from glass, but a number of resin films are now used to produce lightweight and flexible polarizers. Although many resins have been suggested for use in protective cover sheets including, cellulosics, acrylics, cyclic olefin polymers, polycarbonates, and sulfones, acetyl cellulose polymers are most commonly used in protective cover sheets for polarizer plates. Polymers of the acetyl cellulose type are commercially available in a variety of molecular weights as well as the degree of acyl substitution of the hyroxyl groups on the cellulose backbone. Of these, the fully substituted polymer, triacetyl cellulose (TAC) is commonly used to manufacture resin films for use in protective cover sheets for polarizer plates.

The cover sheet normally requires a surface treatment to insure good adhesion to the PVA dichroic film. When TAC is used as the protective cover film of a polarizer plate, the TAC film is subjected to treatment in an alkali bath to saponify the TAC surface to provide suitable adhesion to the PVA dichoroic film. The alkali treatment uses an aqueous solution containing a hydroxide of an alkali metal, such as sodium hydroxide or potassium hydroxide. After alkali treatment, the cellulose acetate film is typically washed with weak acid solution followed by rinsing with water and drying. This saponification process is both messy and time consuming. U.S. Pat. No. 2,362,580 describes a laminar structure wherein two cellulose ester films each having a surface layer containing cellulose nitrate and a modified PVA is adhered to both sides of a PVA film. JP 06094915A discloses a protective film for polarizer plates wherein the protective film has a hydrophilic layer which provides adhesion to PVA film.

Some LCD devices may contain a polarizer plate having a protective cover sheet that also serves as a compensation film to improve the viewing angle of an image. Alternatively, the LCD device may contain one or more separate films that serve as the compensation films. Compensation films (i.e. retardation films or phase difference films) are normally prepared from amorphous films that have a controlled level of birefringence produced either by uniaxial stretching of the film or by coating the film with an optically anisotropic layer. Suitable resins suggested for formation of compensation films by stretching include polyvinyl alcohols, polycarbonates and sulfones. Compensation films prepared by coating with an anisotropic layer normally require highly transparent resin films having low birefringence such as TAC and cyclic olefin polymers.

Protective cover sheets may require the application of other functional layers (herein also referred to as auxiliary layers) such as an antiglare layer, antireflection layer, anti-smudge layer, or antistatic layer. Generally, these functional layers are applied in a process step that is separate from the manufacture of the resin film.

Regardless of their end usage, the precursor resin films used to prepare the various types of optical components described above are generally desired to have high transparency, high uniformity, and low birefringence. Moreover, these films may be needed in a range of thickness depending on the final application.

In general, resin films are prepared either by melt extrusion methods or by casting methods. Melt extrusion methods involve heating the resin until molten (approximate viscosity on the order of 100,000 cp), and then applying the hot molten polymer to a highly polished metal band or drum with an extrusion die, cooling the film, and finally peeling the film from the metal support. For many reasons, however, films prepared by melt extrusion are generally not suitable for optical applications. Principal among these is the fact that melt extruded films exhibit a high degree of optical birefringence. In the case of many polymers there is the additional problem of melting the polymer. For example, highly saponified polyvinyl alcohol has a very high melting temperature of 230 degrees Celsius, and this is above the temperature where discoloration or decomposition begins (˜200 degrees Celsius). Similarly, cellulose triacetate polymer has a very high melting temperature of 270-300° C., and this is above the temperature where decomposition begins. In addition, melt extruded films are known to suffer from other artifacts such as poor flatness, pinholes and inclusions. Such imperfections may compromise the optical and mechanical properties of optical films. For these reasons, melt extrusion methods are generally not suitable for fabricating many resin films intended for optical applications. Rather, casting methods are generally used to producing these films.

Resin films for optical applications are manufactured almost exclusively by casting methods. Casting methods involve first dissolving the polymer in an appropriate solvent to form a dope having a high viscosity on the order of 50,000 cp, and then applying the viscous dope to a continuous highly polished metal band or drum through an extrusion die, partially drying the wet film, peeling the partially dried film from the metal support, and conveying the partially dried film through an oven to more completely remove solvent from the film. Cast films typically have a final dry thickness in the range of 40-200 μm. In general, thin films of less than 40 μm are very difficult to produce by casting methods due to the fragility of wet film during the peeling and drying processes. Films having a thickness of greater than 200 μm are also problematic to manufacture due to difficulties associated with the removal of solvent in the final drying step. Although the dissolution and drying steps of the casting method add complexity and expense, cast films generally have better optical properties when compared to films prepared by melt extrusion methods, and problems associated with high temperature processing are avoided.

Examples of optical films prepared by casting methods include: 1.) Polyvinyl alcohol sheets used to prepare light polarizers as disclosed in U.S. Pat. No. 4,895,769 to Land and U.S. Pat. No. 5,925,289 to Cael as well as more recent disclosures in U.S. patent application Ser. No. 2001/0039319 A1 to Harita and U.S. patent application Ser. No. 2002/001700 A1 to Sanefuji, 2.) Cellulose triacetate sheets used for protective covers for light polarizers as disclosed in U.S. Pat. No. 5,695,694 to Iwata, 3.) Polycarbonate sheets used for protective covers for light polarizers or for retardation plates as disclosed in U.S. Pat. No. 5,818,559 to Yoshida and U.S. Pat. Nos. 5,478,518 and 5,561,180 both to Taketani, and 4.) Polysulfone sheets used for protective covers for light polarizers or for retardation plates as disclosed in U.S. Pat. Nos. 5,611,985 to Kobayashi and U.S. Pat. Nos. 5,759,449 and 5,958,305 both to Shiro.

One disadvantage to the casting method is that cast films have significant optical birefringence. Although films prepared by casting methods have lower birefringence when compared to films prepared by melt extrusion methods, birefringence remains objectionably high. For example, cellulose triacetate films prepared by casting methods exhibit in-plane retardation of 7 nanometers (nm) for light in the visible spectrum as disclosed in U.S. Pat. No. 5,695,694 to Iwata. A polycarbonate film prepared by the casting method is disclosed as having an in-plane retardation of 17 nm in U.S. Pat. Nos. 5,478,518 and 5,561,180 both to Taketani. U.S. patent application Ser. No. 2001/0039319 A1 to Harita claims that color irregularities in stretched polyvinyl alcohol sheets are reduced when the difference in retardation between widthwise positions within the film is less than 5 nm in the original unstretched film.

Commonly-assigned U.S. patent application Publications Nos. 2003/0215658A, 2003/0215621A, 2003/0215608A, 2003/0215583A, 2003/0215582A, 2003/0215581A, 2003/0214715A to Bermel describe a coating method to prepare resin films having low in-plane retardation that are suitable for optical applications. Bermel is silent with respect to the importance of out-of-plane retardation or the means to achieve low out-of-plane retardation values. In these Bermel references the resin films are applied onto a discontinuous, sacrificial substrate from lower viscosity polymer solutions than are normally used to prepare cast films. A wide variety of substrates are disclosed including those having high surface energies such as untreated polyethylene terephthalate (PET), glass, and aluminum (suface energy values of 47, 49.4, and 49 erg/cm², respectively).

For some applications of optical films, both low in-plane and low out-of-plane retardation values are desirable. In particular, values of in-plane retardation and out-of-plane redardation of less than 10 nm may be preferred.

Birefringence in cast films arises from orientation of polymers during the manufacturing operations. This molecular orientation causes indices of refraction within the plane of the film to be measurably different. Two components of birefringence are usually considered in the characterization of optical films, both of which can impact in different ways the performance of optical devices comprising said films. In-plane birefringence is the difference between indices of refraction for polarized light traversing in perpendicular directions normal to the film plane. The out-of-plane birefringence represents the difference between the average of two refractive indices for light traversing in two perpendicular directions normal to the film plane and the refractive index for light traversing parallel to the film surface. The absolute value of birefringence multiplied by the film thickness is defined as in-plane retardation. Therefore, in-plane retardation and out-of-plane retardation are two independent measures of the molecular anisotropy within the plane of the film.

During the casting process, molecular orientation may arise from a number of sources, including shear of the dope in the die, shear of the dope by the metal support during application, shear of the partially dried film during the peeling step, and shear of the free-standing film during conveyance through the final drying step. These shear forces orient the polymer molecules and ultimately give rise to undesirably high birefringence or retardation values. To minimize shear and obtain the lowest birefringence films, casting processes are typically operated at very low line speeds of 1-15 m/min as disclosed in U.S. Pat. No. 5,695,694 to Iwata. Slower line speeds generally produce the highest quality films. This approach can minimize the in-plane retardation, however the out-of-plane retardation may still be quite high. The out-of-plane retardation is often caused by drying stresses generated in the vicinity of an adhering surface. EPA 0 380 02B to Machell and Greener disclosed that by lowering the adhesion of the casting solution to the substrate in a batch casting method, the out-of-plane retardation of the film can be reduced. This can be accomplished, e.g., by lowering the surface energy of the substrate.

Another drawback to the casting method is the inability to accurately apply multiple layers. As noted in U.S. Pat. No. 5,256,357 to Hayward, conventional multi-slot casting dies create unacceptably non-uniform films. In particular, line and streak non-uniformity is greater than 5% with prior art devices. Acceptable two layer films may be prepared by employing special die lip designs as taught in U.S. Pat. No. 5,256,357 to Hayward, but the die designs are complex and may be impractical for applying more than two layers simultaneously.

Another drawback to the casting method is the restrictions on the viscosity of the dope. In casting practice, the viscosity of dope is on the order of 50,000 cp. For example, U.S. Pat. No. 5,256,357 to Hayward describes practical casting examples using dopes with a viscosity of 100,000 cp. In general, cast films prepared with lower viscosity dopes are known to produce non-uniform films as noted for example in U.S. Pat. No. 5,695,694 to Iwata. In U.S. Pat. No. 5,695,694 to Iwata, the lowest viscosity dopes used to prepare casting samples are approximately 10,000 cp. At these high viscosity values, however, casting dopes are difficult to filter and degas. While fibers and larger debris may be removed, softer materials such as polymer slugs are more difficult to filter at the high pressures found in dope delivery systems. Particulate and bubble artifacts create conspicuous inclusion defects as well as streaks and may create substantial waste.

In addition, the casting method can be relatively inflexible with respect to product changes. Because casting requires high viscosity dopes, changing product formulations requires extensive down time for cleaning delivery systems to eliminate the possibility of contamination. Particularly problematic are formulation changes involving incompatible polymers and solvents. In fact, formulation changes are so time consuming and expensive with the casting method that most production machines are dedicated exclusively to producing only one film type.

The manufacture of resin films by the casting method is also confounded by a number of artifacts associated with the stripping and conveyance operations. Stripping operations, for example, frequently require converting aids such as special co-solvents or additives in the casting formulation to facilitate peeling of the film from the metal substrate without creating streak artifacts. In fact, stripping can be so problematic that some films such as polymethylmethacrylate films can not be manufactured by casting methods without resorting to specialty co-polymers as noted in U.S. Pat. Nos. 4,584,231 and 4,664,859 both to Knoop. In addition to stripping artifacts, cast films may be damaged during conveyance across numerous rollers during the final drying operation. For example, abrasion, scratch and wrinkle artifacts have be noted in polycarbonate films as described in U.S. Pat. No. 6,222,003B1 to Hosoi. To minimize damage during conveyance, cast polycarbonate films require special additives that act as lubricants or surface modifiers, or require a protective laminate sheet, or require knurled edges. However, special additives may compromise film clarity. Moreover, lamination and edge knurling devices are expensive and add complexity to the casting process.

Finally, cast films may exhibit undesirable cockle or wrinkles. Thinner films are especially vulnerable to dimensional artifacts either during the peeling and drying steps of the casting process or during subsequent handling of the film. In particular, the preparation of composite optical plates from resin films requires a lamination process involving application of adhesives, pressure, and high temperatures. Very thin films are difficult to handle during this lamination process without wrinkling. In addition, many cast films may naturally become distorted over time due to the effects of moisture. For optical films, good dimensional stability is necessary during storage as well as during subsequent fabrication of composite optical plates.

It is a problem to be solved to provide an optical resin film composite comprising a polymer film that exhibit good dimensional stability and both low in-plane birefringence and low out-of-plane birefringence and a process for forming such films.

### SUMMARY OF THE INVENTION

The invention provides a process for forming an optical resin film, having an out-of-plane retardation of less than 100 nm and an in-plane retardation of less than 20 nm, comprising the steps of:

(a) applying a liquid optical resin /solvent mixture onto the surface of a moving discontinuous carrier substrate in a roll-to-roll process having a surface energy level less than 35 erg/cm²;

(b) drying the liquid resin/solvent mixture to substantially remove the solvent yielding a composite of a resin film weakly adhered to the carrier substrate, the resin film being releasably adhered to the carrier substrate thereby allowing the resin film to be peeled from the carrier substrate, and

(c) removing the film from the substrate, with the formed film exhibiting out-of-plane of less than 100 nm and in-plane retardation of less than 20 nm.

The invention also provides an optical resin film, a composite element, a polarizer plate and a display device. Optical resin films prepared by the current invention exhibit good dimensional stability and low in-plane and out-of-plane birefringence.

The fabrication of these optical resin films is facilitated by the carrier substrate that supports the wet optical film coating through the drying process and eliminates the need to peel the film from a metal band or drum prior to a final drying step as required in the casting methods described in prior art. Rather, the optical film is completely dried before separation from the carrier substrate. In fact, the composite element comprising the optical film and carrier substrate are preferably wound into rolls and stored until needed.

### BRIEF DESCRIPTION OF THE DRAWINGS

FIG. 1 is a schematic of an exemplary roll-to-roll coating and drying apparatus that can be used in the practice of the method of the present invention.

FIG. 2 is a schematic of an exemplary roll-to-roll coating and drying apparatus of FIG. 1 including a station where the resin web separated from the substrate is separately wound.

FIG. 3 is a schematic of an exemplary multi-slot coating apparatus that can be used in the practice of the method of the present invention.

FIG. 4 shows a cross-sectional representation of a resin film formed by the method of the present invention that is partially peeled from a carrier substrate having low surface energy.

FIG. 5 shows a cross-sectional representation of a resin film formed by the method of the present invention that is partially peeled from a carrier substrate having a low surface energy subbing layer formed thereon.

FIG. 6 shows a cross-sectional representation of a multi-layer resin film formed by the method of the present invention that is partially peeled from a carrier substrate having low surface energy.

FIG. 7 shows a cross-sectional representation of a multi-layer resin film formed by the method of the present invention that is partially peeled from a carrier substrate having a low surface energy subbing layer formed thereon.

FIG. 8 is a schematic of a casting apparatus as used in prior art to cast resin films.

FIG. 9 shows the dependence of the out-of-plane retardation on film thickness for a solid polycarbonate resin cast from a methylene chloride solution onto a variety of substrates with different surface energies.

### DETAILED DESCRIPTION OF THE INVENTION

It is an object of the present invention to overcome the limitations of prior art casting methods and provide a new roll-to-roll coating method for preparing amorphous polymeric films having very low levels of both in-plane and out-of-plane birefringence. It is a further object of the present invention to provide a new method of producing highly uniform polymeric films over a broad range of dry thicknesses.

Yet another object of the present invention is to provide a method of preparing polymeric films by simultaneously applying multiple layers to a moving substrate in a roll-to-roll process. Still another object of the present invention is to provide a new method of preparing polymeric films with improved dimensional stability and handling ability by temporarily adhering the resin film to a supporting carrier substrate at least until it is substantially dry and then subsequently separating the carrier substrate from the resin film.

A further object of the present invention is to provide a composite element comprising a resin film coated on a discontinuous carrier substrate, the substrate having a low surface energy and the resin film having an in-plane retardation that is less than 20 nm and an out-of-plane retardation that is less than 100 nm, the resin film being adhered to the carrier substrate with an adhesive strength of less than about 250 N/m. Another object of the present invention is to provide a resin film comprising a layer of a polycarbonate formed by a coating operation, the polycarbonate film having an in-plane retardation that is less than 20 nm and an out-of-plane retardation that is less than 100 nm. A still further object of the present invention is to provide a resin film comprising a layer of a cellulose ester formed by a coating operation, the cellulose ester film having an in-plane retardation that is less than 20 nm and an out-of-plane retardation that is less than 20 nm.

Briefly stated, the foregoing and numerous other features, objects and advantages of the present invention will become readily apparent upon review of the detailed description, claims and drawings set forth herein. These features, objects and advantages are accomplished by applying a low viscosity fluid containing polymeric resins onto a moving, discontinuous carrier substrate by a coating method. Unlike the continuous metal bands or wheels typically used to cast resin films, the discontinuous carrier substrate employed in the present invention is a noncontinuous substrate having length of at least 10 meters, preferably at least 1000 meters. The carrier substrate is modified to possess surface energy less than 35 erg/cm². Preferably, the surface energy is between 15 and 35 erg/cm². Above a surface energy of 35 erg/cm² it is very difficult to achieve low out-of-plane retardation films. Surface energies below about 15 erg/cm² are impractical from the standpoint of coating, wetting and providing sufficient adhesion of the dried resin film to the substrate. The resin film is not separated from the carrier substrate until the coated film is substantially dry (<10% residual solvent by weight). In fact, the composite structure of resin film and carrier substrate may be wound into rolls and stored until needed. Typically, these rolls are at least 10 meters in length, preferably the rolls are 1000 meters or more in length. Thus, the carrier substrate cradles the optical resin film and protects against shearing forces during conveyance through the drying process. Moreover, because the resin film is dry and solid when it is finally peeled from the carrier substrate, there is no shear or orientation of polymer within the film due to the peeling process. As a result, films prepared by the current invention exhibit very low levels of in-plane and out-of-plane birefringence.

Polymeric films can be made with the method of the present invention having a thickness of about 1 to 200 microns. Very thin resin films of less than 40 microns can be easily manufactured at line speeds not possible with prior art methods. The fabrication of very thin films is facilitated by a carrier substrate that supports the wet film through the drying process and eliminates the need to peel the film from a metal band or drum prior to a final drying step as required in the casting methods described in prior art. Rather, the film is substantially if not completely dried before separation from the carrier substrate. In all cases, dried resin films have a residual solvent content of less than 10% by weight. In a preferred embodiment of the present invention, the residual solvent content is less than 5%, and most preferably less than 1%. Thus, the present invention readily allows for preparation of very delicate thin films not possible with the prior art casting method. In addition, thick films of greater than 40 microns may also be prepared by the method of the present invention. To fabricate thicker films, additional coatings may be applied over a film-substrate composite either in a tandem operation or in an offline process without comprising optical quality. In this way, the method of the present invention overcomes the limitation of solvent removal during the preparation of thicker films since the first applied film is dry before application of a subsequent wet film. Thus, the present invention allows for a broader range of final film thickness than is possible with casting methods.

In the method of the present invention, resin films are created by forming a single layer or, preferably, a multilayer composite on a slide surface of a coating hopper, the multilayer composite including a bottom layer of low viscosity, one or more intermediate layers, and an optional top layer containing a surfactant, flowing the multilayer composite down the slide surface and over a coating lip of the coating hopper, and applying the multilayer composite to a moving substrate. In particular, the use of the method of the present invention is shown to allow for application of several liquid layers having unique composition. Coating aids and additives may be placed in specific layers to improve film performance or improve manufacturing robustness. For example, multilayer application allows a surfactant to be placed in the top spreading layer where needed rather than through out the entire wet film. In another example, the concentration of polymer in the lowermost layer may be adjusted to achieve low viscosity and facilitate high-speed application of the multilayer composite onto the carrier substrate. Therefore, the present invention provides an advantageous method for the fabrication of multiple layer composite films such as required for certain optical elements or other similar elements.

Wrinkling and cockle artifacts are minimized with the method of the present invention through the use of the carrier substrate. By providing a stiff backing for the resin film, the carrier substrate minimizes dimensional distortion of the optical film. This is particularly advantageous for handling and processing very thin films of less than about 40 microns. Moreover, scratches and abrasion artifacts that are known to be created by the casting method are avoided with the method of the present invention since the carrier substrate lies between the resin film and potentially abrasive conveyance rollers during all drying operations. In addition, the restraining nature of the carrier substrate also eliminates the tendency of resin films to distort or cockle over time as a result of changes in moisture levels. Thus, the method of the current invention insures that polymeric optical films are dimensionally stable during preparation and storage as well as during final handling steps necessary for fabrication of optical elements.

In the practice of the method of the present invention it is preferred that the substrate be a discontinuous sheet such as polyethylene terephthalate (PET) that is conveniently supplied by unwinding a roll of substrate having a length of at least 10 meters. The PET carrier substrate may be pretreated with a coated surface layer or an electrical discharge device to modify its surface energy. In particular, a coated surface layer may be applied to lower the surface energy of the substrate, and allow the film to be subsequently peeled away from the substrate while producing low levels of out-of-plane retardation.

Although the present invention is discussed herein with particular reference to a slide bead coating operation, those skilled in the art will understand that the present invention can be advantageously practiced with other coating operations. For example, freestanding films having low in-plane and out-of-plane retardation should be achievable with single or multiple layer slot die coating operations and single or multiple layer curtain coating operations. Moreover, those skilled in the art will recognize that the present invention can be advantageously practiced with alternative carrier substrates. For example, peeling films having low in-plane and out-of-plane birefringence should be achievable with other polymeric supports [e.g. polyethylene naphthalate (PEN), cellulose acetate, PET], paper supports, resin laminated paper supports, and metal supports (e.g. aluminum) so long as these supports are treated to possess low surface energy.

Practical applications of the present invention include the preparation of polymeric films used as optical films, laminate films, release films, photographic films, and packaging films among others. In particular, resin films prepared by the method of the present invention may be utilized as optical elements in the manufacture of electronic displays such as liquid crystal displays. For example, liquid crystal displays are comprised of a number of film elements including polarizer plates, compensation plates and electrode substrates. Polarizer plates are typically a multilayer composite structure having dichroic film (normally stretched polyvinyl alcohol treated with iodine) with each surface adhered to a protective cover having very low in-plane birefringence. The low resin films prepared by the method of the present invention are suitable protective sheets and also as precursor films for the formation of light polarizers. The resin films prepared by the method of the present invention are also suitable for the manufacture of compensation plates and electrode substrates.

The films produced with the method of the present invention are particularly useful for optical films. As produced, the films made with the method of the present invention will have a light transmittance of at least about 85 percent, preferably at least about 90 percent, and most preferably, at least about 95 percent. Further, as produced the films will have a haze value of less than 1.0 percent. In addition, the films are smooth with a surface roughness average (Ra, ANSI Standard B46.1, 1985) of less than 100 nm and most preferrably with a surface roughness of less than 50 nm.

The terms “optical resins” and “optical films” as used herein are used to describe any polymeric material that forms a high clarity film with high light transmittance (i.e. >85%) and low haze values (i.e.<1.0%). Examplary optical resins include those described here, i.e. cellulose triacetate (also referred to as triacetyl cellulose, TAC), polyvinyl alcohol, polycarbonate, polyethersulfone, polymethylmethacrylate, and polyvinylbutyral. Other potential optical resins might include fluoropolymers (polyvinylidene fluoride, polyvinyl fluoride, and polycholorotrifluorethene), other cellulosic esters (cellulose diacetate, cellulose acetate butyrate, and cellulose acetate propionate, for example), polyoefins (cyclic olefin polymers), polystyrene, aromatic polyesters (polyarylates and polyethylene terephthalate), sulfones (polysulfones, polyethersulfones, polyarylsulfone), and polycarbonate copolymers, among others.

In one preferred embodiment, the optical resin film is a polycarbonate film having an in-plane retardation that is less than 20 nm and an out-of-plane retardation that is less than 100 nm. Most preferably the out-of-plane retardation is less than 80 nm. Polycarbonates are condensation polymers having the general structure of 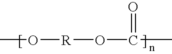
where R is an organic moiety derived from a monomeric diol. Most common polycarbonates are derived from bis phenol A monomer [2,2 bis (4 hydroxy-phenyl)propane] but other monomers can be used in themselves or in combination with other diols to form a multitude of polycarbonate structures. Most polycarbonates, having an aromatic backbone structure, are inherently birefringent materials that produce high levels of out-of-plane retardation, typically much higher than that produced by TAC resin, in films cast therefrom.

In another preferred embodiment, the optical resin film is a cellulose ester film having an in-plane retardation that is less than 20 nm and an out-of-plane retardation that is less than 20 nm. Preferably the out-of-plane retardation is less than 10 nm, most preferably less than 5 nm.

Turning first to FIG. 1 there is shown a schematic of an exemplary and well known roll-to-roll coating and drying system 10 suitable for practicing the method of the present invention. The coating and drying system 10 is typically used to apply very thin films to a moving substrate 12 and to subsequently remove solvent in a dryer 14. A single coating apparatus 16 is shown such that system 10 has only one coating application point and only one dryer 14, but two or three (even as many as six) additional coating application points with corresponding drying sections are known in the fabrication of composite thin films. The process of sequential application and drying is known in the art as a tandem coating operation.

Coating and drying apparatus 10 includes an unwinding station 18 to feed the moving substrate 12 around a back-up roller 20 where the coating is applied by coating apparatus 16. The coated web 22 then proceeds through the dryer 14. In the practice of the method of the present invention the final dry film 24 comprising a resin film on substrate 12 is wound into rolls at a wind-up station 26.

As depicted, an exemplary four-layer coating is applied to moving web 12. Coating liquid for each layer is held in respective coating supply vessel 28, 30, 32, 34. The coating liquid is delivered by pumps 36, 38, 40, 42 from the coating supply vessels to the coating apparatus 16 conduits 44, 46, 48, 50, respectively. In addition, coating and drying system 10 may also include electrical discharge devices, such as corona or glow discharge device 52, or polar charge assist device 54, to modify the substrate 12 prior to application of the coating.

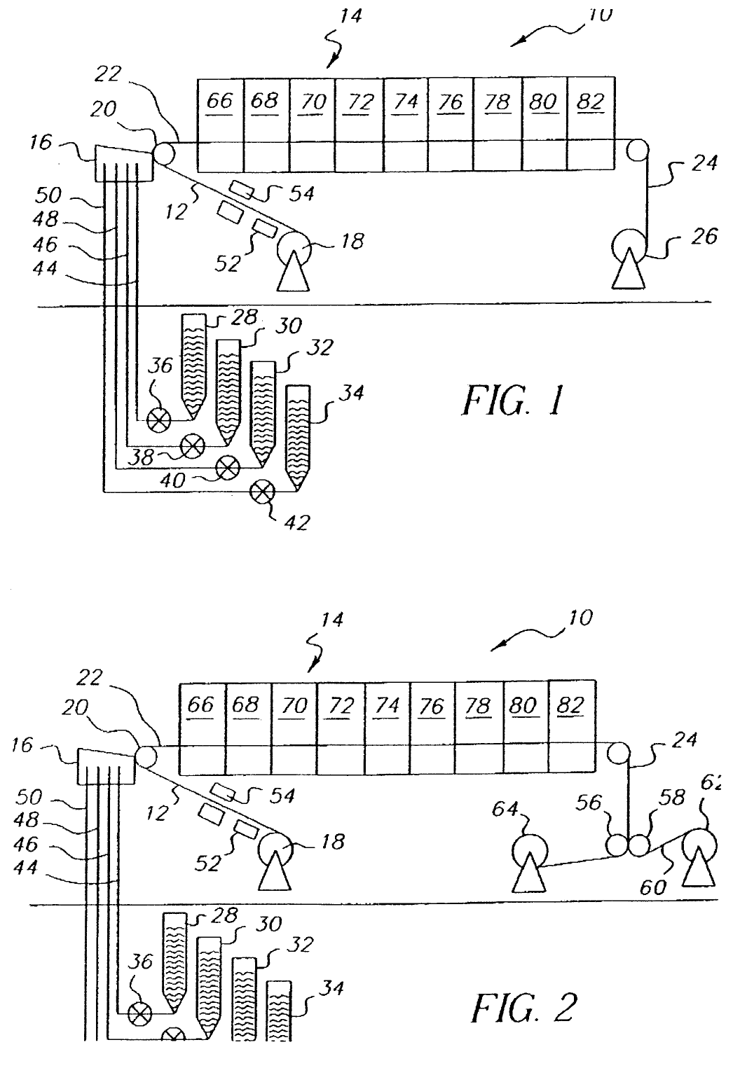

Turning next to FIG. 2 there is shown a schematic of the same exemplary coating and drying system 10 depicted in FIG. 1 with an alternative winding operation. Accordingly, the drawings are numbered identically up to the winding operation. In the practice of the method of the present invention, the dry film 24 comprising a substrate (which may be a resin film, paper, resin coated paper or metal) with a resin coating applied thereto is taken between opposing rollers 56, 58. The resin film 60 is peeled from substrate 12 with the optical film going to winding station 62 and the substrate 12 going to winding station 64. In a preferred embodiment of the present invention, polyethylene terephthalate (PET) is used as the substrate 12. The substrate 12 may be pretreated with a subbing layer to modify the surface energy of the substrate 12.

The coating apparatus 16 used to deliver coating fluids to the moving substrate 12 may be a multilayer applicator such as a slide bead hopper, as taught for example in U.S. Pat. No. 2,761,791 to Russell, or a slide curtain hopper, as taught by U.S. Pat. No. 3,508,947 to Hughes. Alternatively, the coating apparatus 16 may be a single layer applicator, such as a slot die hopper or a jet hopper. In a preferred embodiment of the present invention, the application device 16 is a multilayer slide bead hopper.

As mentioned above, coating and drying system 10 includes a dryer 14 that will typically be a drying oven to remove solvent from the coated film. An exemplary dryer 14 used in the practice of the method of the present invention includes a first drying section 66 followed by eight additional drying sections 68-82 capable of independent control of temperature and air flow. Although dryer 14 is shown as having nine independent drying sections, drying ovens with fewer compartments are well known and may be used to practice the method of the present invention. In a preferred embodiment of the present invention the dryer 14 has at least two independent drying zones or sections.

Preferably, each of drying sections 68-82 has independent temperature and airflow controls. In each section, temperature may be adjusted between 5° C. and 150° C. To minimize drying defects from case hardening or skinning-over of the wet film, optimum drying rates are needed in the early sections of dryer 14. There are a number of artifacts created when temperatures in the early drying zones are inappropriate. For example, fogging or blush of polycarbonate films is observed when the temperature in zones 66, 68 and 70 are set at 25° C. This blush defect is particularly problematic when high vapor pressure solvents (methylene chloride and acetone) are used in the coating fluids. Aggressively high temperatures are also associated with other artifacts such as case hardening, reticulation patterns and microvoids in the resin film. In a preferred embodiment of the present invention, the first drying section 66 is operated at a temperature of at least about 25° C. but less than 95° C. with no direct air impingement on the wet coating of the coated web 22. In another preferred embodiment of the method of the present invention, drying sections 68 and 70 are also operated at a temperature of at least about 25° C. but less than 95° C. The actual drying temperature in drying sections 66, 68 may be optimized empirically within this range by those skilled in the art.

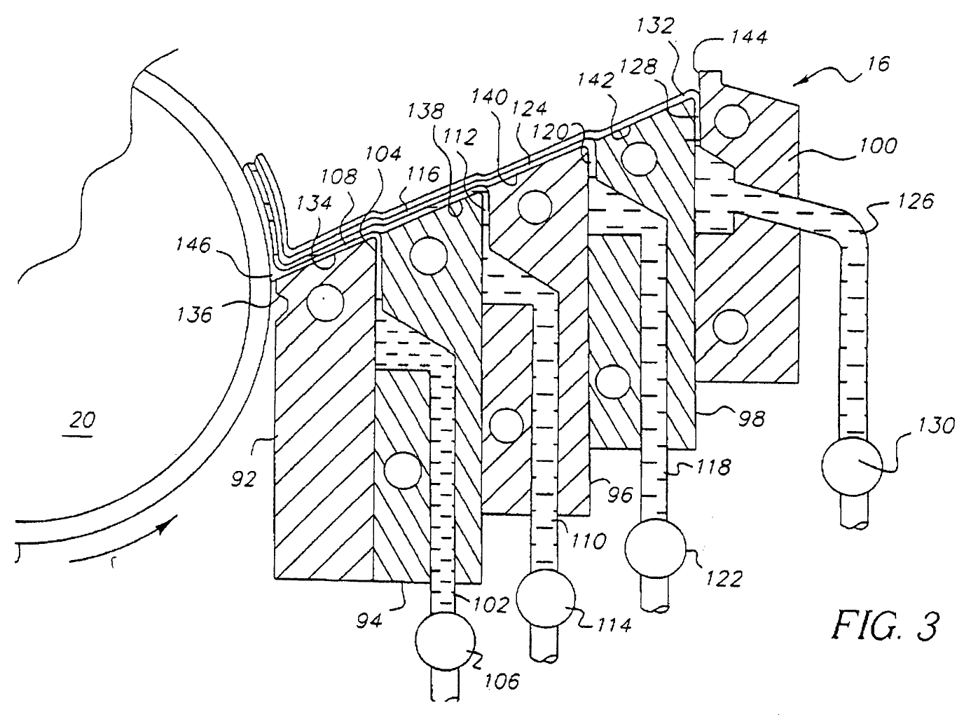

Referring now to FIG. 3, a schematic of an exemplary coating apparatus 16 is shown in detail. Coating apparatus 16, schematically shown in side elevational cross-section, includes a front section 92, a second section 94, a third section 96, a fourth section 98, and a back plate 100. There is an inlet 102 into second section 94 for supplying coating liquid to first metering slot 104 via pump 106 to thereby form a lowermost layer 108. There is an inlet 110 into third section 96 for supplying coating liquid to second metering slot 112 via pump 114 to form layer 116. There is an inlet 118 into fourth section 98 for supplying coating liquid to metering slot 120 via pump 122 to form layer 124. There is an inlet 126 into back plate 100 for supplying coating liquid to metering slot 128 via pump 130 to form layer 132. Each slot 104, 112, 120, 128 includes a transverse distribution cavity. Front section 92 includes an inclined slide surface 134, and a coating lip 136. There is a second inclined slide surface 138 at the top of second section 94. There is a third inclined slide surface 140 at the top of third section 96. There is a fourth inclined slide surface 142 at the top of fourth section 98. Back plate 100 extends above inclined slide surface 142 to form a back land surface 144. Residing adjacent the coating apparatus or hopper 16 is a coating backing roller 20 about which a web 12 is conveyed. Coating layers 108, 116, 124, 132 form a multilayer composite which forms a coating bead 146 between lip 136 and substrate 12. Typically, the coating hopper 16 is movable from a non-coating position toward the coating backing roller 20 and into a coating position. Although coating apparatus 16 is shown as having four metering slots, coating dies having a larger number of metering slots (as many as nine or more) are well known and may be used to practice the method of the present invention.

Coating fluids are comprised principally of polymeric resins dissolved in a suitable solvent. Suitable resins include any polymeric material that may be used to form a transparent film. Practical examples of resins currently used to form optical films include polyvinyl alcohols for polarizers, polyvinylbutyrals for glass laminates, acrylics, and polystyrene as protective covers and substrates, as well as cellulosic esters, polycarbonates, and polyarylates, polyolefins, fluoroplastics (e.g. polyvinylfluoride and polyvinylidene fluoride), sulfones for protective covers, compensation plates, and electrode substrates. In the method of the present invention, there are no particular limitations as to the type polymers or blends of polymers that may be used to form optical films.

In terms of solvents for the aforementioned resin materials, suitable solvents include, for example, chlorinated solvents (methylene chloride and 1,2 dichloroethane), alcohols (methanol, ethanol, n-propanol, isopropanol, n-butanol, isobutanol, diacetone alcohol, phenol, and cyclohexanol), ketones (acetone, methylethyl ketone, methylisobutyl ketone, and cyclohexanone), esters (methyl acetate, ethyl acetate, n-propyl acetate, isopropyl acetate, isobutyl acetate, and n-butyl acetate), aromatics (toluene and xylenes) and ethers (tetrahydrofuran, 1,3-dioxolane, 1,2-dioxolane, 1,3-dioxane, 1,4-dioxane, and 1,5-dioxane). Water may also be used as a solvent. Coating solutions may also be prepared with a blend of the aforementioned solvents.

Coating fluids may also contain additives to act as converting aids. Converting aids include plasticizers and surfactants, and these additives are generally specific to the type of polymer film. For example, plasticizers suitable for polycarbonate, polyethersulfone, and cellulose triacetate films include phthalate esters (diethylphthalate, dibutylphthalate, dicyclohexylphthalate, dioctylphthalate, and butyl octylphthalate), adipate esters (dioctyl adipate), and phosphate esters (tricresyl phosphate and triphenyl phosphate). For the water-soluble polyvinyl alcohols, on the other hand, suitable plasticizers include polyhydric alcohols such as glycerin and ethylene glycol as well as amine alcohols such as ethanolamine. Plasticizers may be used here as coating aids in the converting operation to minimize premature film solidification at the coating hopper and to improve drying characteristics of the wet film. In the method of the present invention, plasticizers may be used to minimize blistering, curl and delamination of resin films during the drying operation. In a preferred embodiment of the present invention, plasticizers may be added to the coating fluid at a total concentration of up to 50% by weight relative to the concentration of polymer in order to mitigate defects in the final resin film.

The coating formulation for the low birefringence polymer may also contain one or more UV absorbing compounds to provide UV filter element performance and/or act as UV stabilizers for the low birefringence polymer film. Ultraviolet absorbing compounds are generally contained in the polymer in an amount of 0.01 to 20 weight parts based on 100 weight parts of the polymer containing no ultraviolet absorber, and preferably contained in an amount of 0.01 to 10 weight parts, especially in an amount of 0.05 to 2 weight parts. Any of the various ultraviolet light absorbing compounds which have been described for use in various polymeric elements may be employed in the polymeric elements of the invention, such as hydroxyphenyl-s-triazine, hydroxyphenylbenzotriazole, formamidine, or benzophenone compounds. As described in copending, commonly assigned U.S. patent application U.S. Ser. No. 10/150,634, filed May 5, 2002, the use of dibenzoylmethane ultraviolet absorbing compounds in combination with a second UV absorbing compound such as those listed above have been found to be particularly advantageous with respect to providing both a sharp cut off in absorption between the UV and visible light spectral regions as well as increased protection across more of the UV spectrum. Additional possible UV absorbers which may be employed include salicylate compounds such as 4-t-butylphenylsalicylate; and [2,2′thiobis-(4-t-octylphenolate)]n-butylamine nickel(II). Most preferred are combinations of dibenzoylmethane compounds with hydroxyphenyl-s-triazine or hydroxyphenylbenzotriazole compounds.

Dibenzoylmethane compounds which may be employed include those of the formula (IV) 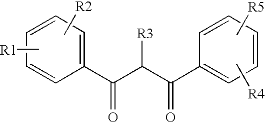
where R1 through R5 are each independently hydrogen, halogen, nitro, or hydroyxl, or further substituted or unsubstituted alkyl, alkenyl, aryl, alkoxy, acyloxy, ester, carboxyl, alkyl thio, aryl thio, alkyl amine, aryl amine, alkyl nitrile, aryl nitrile, arylsulfonyl, or 5-6 member heterocylce ring groups. Preferably, each of such groups comprises 20 or fewer carbon atoms. Further preferably, R1 through R5 of Formula IV are positioned in accordance with Formula IV-A: 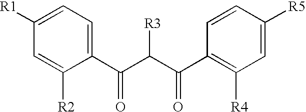
Particularly preferred are compounds of Formula IV-A where R1 and R5 represent alkyl or alkoxy groups of from 1-6 carbon atoms and R2 through R4 represent hydrogen atoms.

Representative compounds of Formula (IV) which may be employed in accordance the elements of the invention include the following: (IV-1): 4-(1,1-dimethylethyl)-4′-methoxydibenzoylmethane (PARSOL® 1789) (IV-2): 4-isopropyl dibenzoylmethane (EUSOLEX® 8020) (IV-3): dibenzoylmethane (RHODIASTAB® 83)

Hydroxyphenyl-s-triazine compounds which may be used in the elements of the invention, e.g., may be a derivative of tris-aryl-s-triazine compounds as described in U.S. Pat. No. 4,619,956. Such compounds may be represented by Formula V: 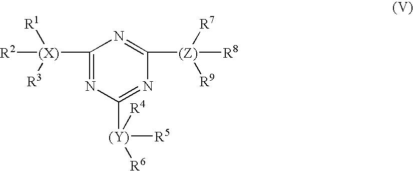
wherein X, Y and Z are each aromatic, carbocylic radicals of less than three 6-membered rings, and at least one of X, Y and Z is substituted by a hydroxy group ortho to the point of attachment to the triazine ring; and each of R1 through R9 is selected from the group consisting of hydrogen, hydroxy, alkyl, alkoxy, sulfonic, carboxy, halo, haloalkyl and acylamino. Particularly preferred are hydroxyphenyl-s-triazines of the formula V-A: 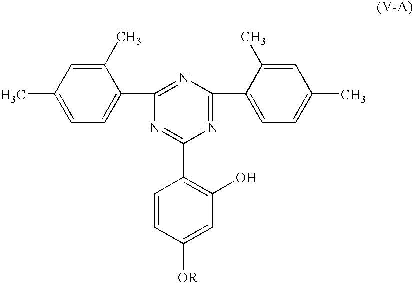
wherein R is hydrogen or alkyl of 1-18 carbon atoms.

Hydroxyphenylbenzotriazole compounds which may be used in the elements of the invention, e.g., may be a derivative of compounds represented by Formula VI: 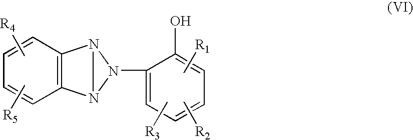
wherein R1 through R5 may be independently hydrogen, halogen, nitro, hydroxy, or further substituted or unsubstituted alkyl, alkenyl, aryl, alkoxy, acyloxy, aryloxy, alkylthio, mono or dialkyl amino, acyl amino, or heterocyclic groups. Specific examples of benzotriazole compounds which may be used in accordance with the invention include 2-(2′-hydroxy-3′-t-butyl-5′-methylphenyl)-5-chlorobenzotriazole; 2-(2′-hydroxy-3′,5′-di-t-amylphenyl)benzotriazole; octyl 5-tert-butyl-3-(5-chloro-2H-benzotriazole-2-yl)-4-hydroxybenzenepropionate; 2-(hydroxy-5-t-octylphenyl)benzotriazole; 2-(2′-hydroxy-5′-methylphenyl)benzotriazole; 2-(2′-hydroxy-3′-dodecyl-5′-methylphenyl)benzotriazole; and 2-(2′-hydroxy-3′,5′-di-t-butylphenyl)-5-chlorobenzotriazole.

Formamidine compounds which may be used in the elements of the invention, e.g., may be a formamidine compound as described in U.S. Pat. No. 4,839,405. Such compounds may be represented by Formula VII or Formula VIII: 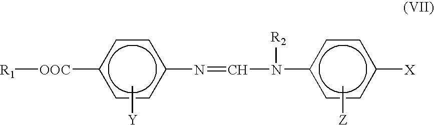
wherein R1 is an alkyl group containing 1 to about 5 carbon atoms; Y is a H, OH, Cl or an alkoxy group; R2 is a phenyl group or an alkyl group containing 1 to about 9 carbon atoms; X is selected from the group consisting of H, carboalkoxy, alkoxy, alkyl, dialkylamino and halogen; and Z is selected from the group consisting of H, alkoxy and halogen; 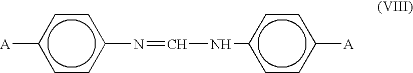
wherein A is —COOR, —COOH, —CONR′R″, —NR′COR, —CN, or a phenyl group; and wherein R is an alkyl group of from 1 to about 8 carbon atoms; R′ and R″ are each independently hydrogen or lower alkyl groups of from 1 to about 4 carbon atoms. Specific examples of formamidine compounds which may be used in accordance with the invention include those described in U.S. Pat. No. 4,839,405, and specifically 4-[[(methylphenylamino)methylene]amino]-ethyl ester.

Benzophenone compounds which may be used in the elements of the invention, e.g., may include 2,2′-dihydroxy-4,4′dimethoxybenzophenone, 2-hydroxy-4-methoxybenzophenone and 2-hydroxy-4-n-dodecyloxybenzophenone.

Coating fluids may also contain surfactants as coating aids to control artifacts related to flow after coating. Artifacts created by flow after coating phenomena include mottle, repellencies, orange-peel (Bernard cells), and edge-withdraw. For polymeric resins dissolved in organic solvents, surfactants used control flow after coating artifacts include siloxane and fluorochemical compounds. Examples of commercially available surfactants of the siloxane type include: 1.) Polydimethylsiloxanes such as DC200 Fluid from Dow Corning, 2.) Poly(dimethyl, methylphenyl)siloxanes such as DC510 Fluid from Dow Corning, and 3.) Polyalkyl substituted polydimethysiloxanes such as DC190 and DC1248 from Dow Corning as well as the L7000 Silwet series (L7000, L7001, L7004 and L7230) from Union Carbide, and 4.) Polyalkyl substituted poly(dimethyl, methylphenyl)siloxanes such as SF1023 from General Electric. Examples of commercially available fluorochemical surfactants include: 1.) Fluorinated alkyl esters such as the Fluorad series (FC430 and FC431) from the 3M Corporation, 2.) Fluorinated polyoxyethylene ethers such as the Zonyl series (FSN, FSN100, FSO, FSO100) from Du Pont, 3.) Acrylate polyperfluoroalkyl ethylacrylates such as the F series (F270 and F600) from NOF Corporation, and 4.) Perfluoroalkyl derivatives such as the Surflon series (S383, S393, and S8405) from the Asahi Glass Company.

For polymeric resins dissolved in aqueous solvents, appropriate surfactants include those suitable for aqueous coating as described in numerous publications (see for example Surfactants: Static and dynamic surface tension by YM Tricot in Liquid Film Coating, pp 99-136, S E Kistler and P M Schweitzer editors, Chapman and Hall [1997]). Surfactants may include nonionic, anionic, cationic and amphoteric types. Examples of practical surfactants include polyoxyethylene ethers, such as polyoxyethylene (8) isooctylphenyl ether, polyoxyethylene (10) isooctylphenyl ether, and polyoxyethylene (40) isooctylphenyl ether, and fluorinated polyoxyethylene ethers such as the Zonyl series commercially available from Du Pont.

In the method of the present invention, there are no particular limits as to the type of surfactant used. In the method of the present invention, surfactants are generally of the non-ionic type. In a preferred embodiment of the present invention, non-ionic compounds of either the siloxane or fluorinated type are added to the uppermost layers when films are prepared with organic solvents.

In terms of surfactant distribution, surfactants are most effective when present in the uppermost layers of the multilayer coating. In the uppermost layer, the concentration of surfactant is preferably 0.001-1.000% by weight and most preferably 0.010-0.500%. In addition, lesser amounts of surfactant may be used in the second uppermost layer to minimize diffusion of surfactant away from the uppermost layer. The concentration of surfactant in the second uppermost layer is preferably 0.000-0.200% by weight and most preferably between 0.000-0.100% by weight. Because surfactants are only necessary in the uppermost layers, the overall amount of surfactant remaining in the final dried film is small.

Although surfactants are not required to practice the method of the current invention, surfactants do improve the uniformity of the coated film. In particular, mottle nonuniformities are reduced by the use of surfactants. In transparent resin films, mottle nonuniformities are not readily visualized during casual inspection. To visualize mottle artifacts, organic dyes may be added to the uppermost layer to add color to the coated film. For these dyed films, nonuniformities are easy to see and quantify. In this way, effective surfactant types and levels may be selected for optimum film uniformity.

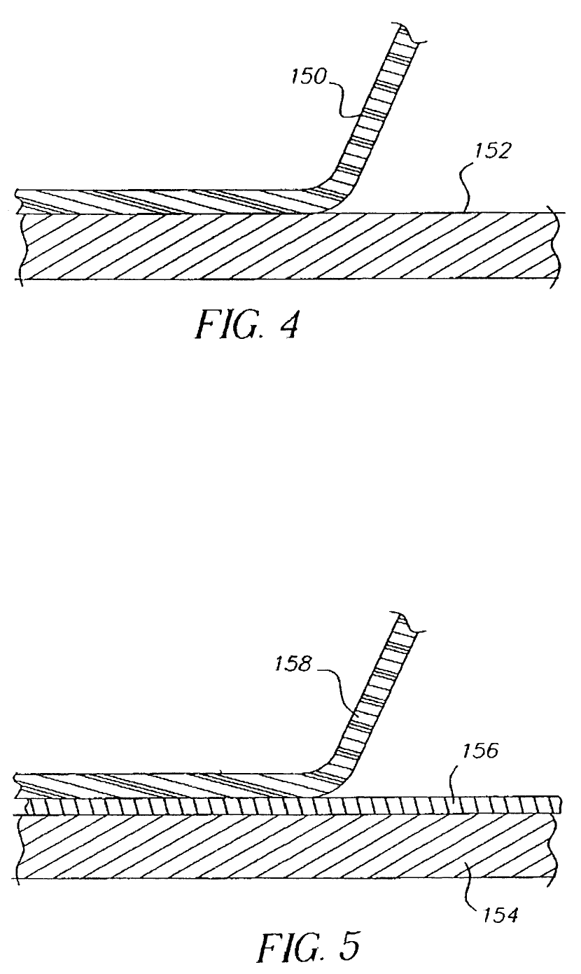

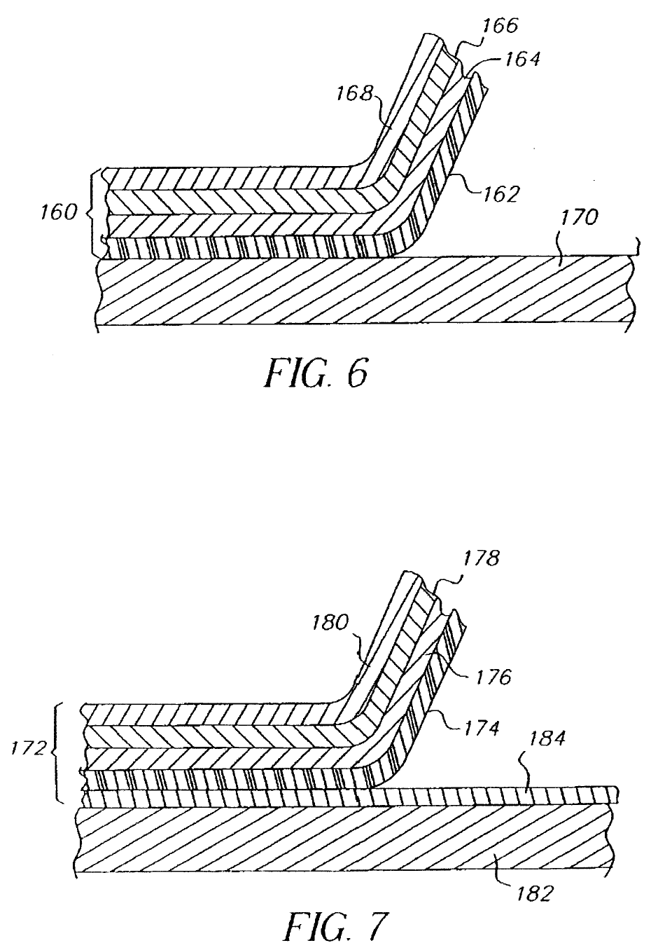

Turning next to FIGS. 4 through 7, there are presented cross-sectional illustrations showing various film configurations prepared by the method of the present invention. In FIG. 4, a single-layer optical film 150 is shown partially peeled from a carrier substrate 152 that has been modified to possess a surface energy less than 35 erg/cm². Optical film 150 may be formed either by applying a single liquid layer to the carrier substrate 152 or by applying a multiple layer composite having a composition that is substantially the same among the layers. Alternatively in FIG. 5, the carrier substrate 154 may have been pretreated with a coated surface layer 156 that modifies the surface energy of the substrate to less than 35 erg/cm². FIG. 6 illustrates a multiple layer film 160 that is comprised of four compositionally discrete layers including a lowermost layer 162 nearest to the carrier support 170 that has been modified to possess a surface energy less than 35 erg/cm², two intermediate layers 164, 166, and an uppermost layer 168. FIG. 6 also shows that the entire multiple layer composite 160 may be peeled from the carrier substrate 170. FIG. 7 shows a multiple layer composite film 172 comprising a lowermost layer 174 nearest to the carrier substrate 182, two intermediate layers 176, 178, and an uppermost layer 180 being peeled from the carrier substrate 182. The carrier substrate 182 has been treated with a coated surface layer 184 to modify the surface energy of the substrate 182. Coated surface layers 156 and 184 may be comprised of any polymeric materials that provide a surface energy of less than 35 erg/cm². Exemplary examples of theses include: fluorinated and chlorinated polymers and latexes, e.g., poly(tetrafluoroethylene), poly(hexafluoropropylene), poly(trifluoroethylene), vinylidene fluoride interpolymers, vinylidene chloride interpolymers, and poly(trifluorochloroethylethylene; polystyrene; polyolefins, e.g., polyethylene and polypropylene; silicone polymers; and others. The coated surface layers may be applied by aqueous or organic solvent coating methods, by melt extrusion coating methods, by vacuum coating methods, or other well known surface coating methods. The choice of materials used in the coated surface layer may be optimized empirically by those skilled in the art to achieve the desired surface energy.

The method of the present invention may also include the step of coating over a previously prepared composite of resin film and carrier substrate. For example, the coating and drying system 10 shown in FIGS. 1 and 2 may be used to apply a second multilayer film to an existing optical film/substrate composite. If the film/substrate composite is wound into rolls before applying the subsequent coating, the process is called a multi-pass coating operation. If coating and drying operations are carried out sequentially on a machine with multiple coating stations and drying ovens, then the process is called a tandem coating operation. In this way, thick films may be prepared at high line speeds without the problems associated with the removal of large amounts of solvent from a very thick wet film. Moreover, the practice of multi-pass or tandem coating also has the advantage of minimizing other artifacts such as streak severity, mottle severity, and overall film nonuniformity.

The practice of tandem coating or multi-pass coating requires some minimal level of adhesion between the first-pass film and the carrier substrate. In some cases, film/substrate composites having poor adhesion are observed to blister after application of a second or third wet coating in a multi-pass operation. To avoid blister defects, adhesion must be greater than 0.3 N/m between the first-pass resin film and the carrier substrate. This level of adhesion may be attained by a variety of web treatments including various subbing layers and various electronic discharge treatments. However, excessive adhesion between the applied film and substrate is undesirable since the film may be damaged during subsequent peeling operations. In particular, film/substrate composites having an adhesive force of greater than 250 N/m have been found to peel poorly. Films peeled from such excessively, well-adhered composites exhibit defects due to tearing of the film and/or due to cohesive failure within the film. In a preferred embodiment of the present invention, the adhesion between the resin film and the carrier substrate is less than 250 N/m. Most preferably, the adhesion between resin film and the carrier substrate is between 0.5 and 25 N/m.

The method of the present invention is suitable for application of resin coatings to a variety of carrier substrates such as polyethylene terephthalate (PET), polyethylene naphthalate (PEN), polystyrene, cellulose triaceate and other polymeric films. Polymeric substrates may be unstretched, unixially stretched or biaxially stretched films or sheets. Additional substrates may include paper, laminates of paper and polymeric films, glass, cloth, aluminum and other metal supports. In some cases, substrates may be pretreated with subbing layers or electrical discharge devices. Substrates may also be pretreated with functional layers containing various binders and addenda. There are no particular requirements regarding the thickness of the substrate. For the optical resin films prepared here the substrate is PET with a thickness of either 100 or 175 μm. The method of the present invention may be practiced using substrates having a thickness of 5 to 500 μm.

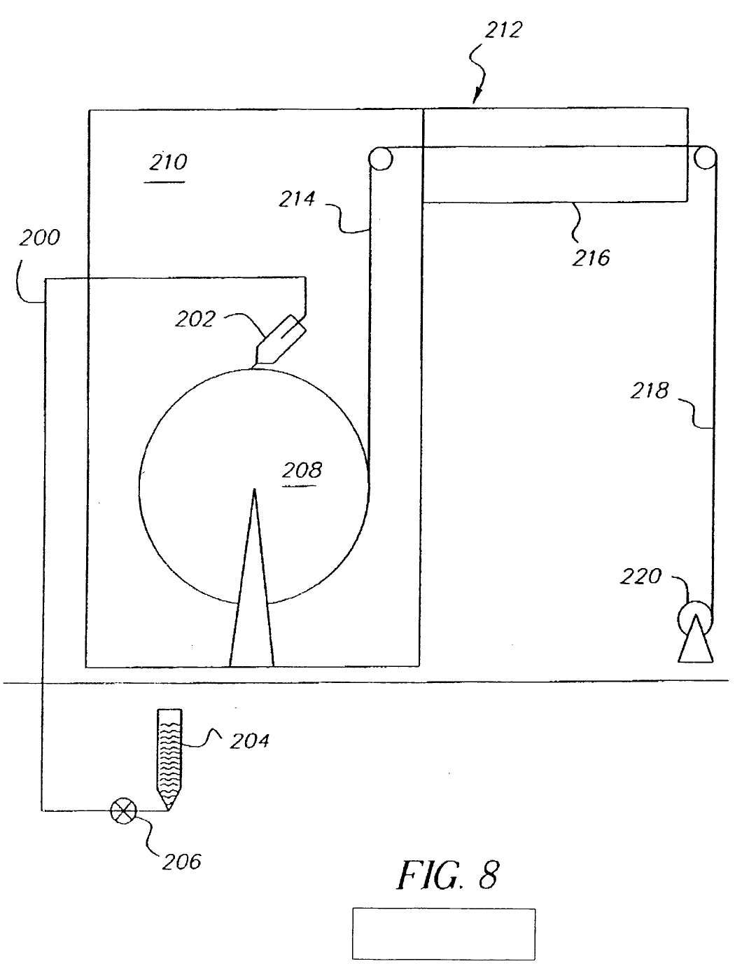

The prior art method of casting resin films is illustrated in FIG. 8. As shown in FIG. 8, a viscous polymeric dope is delivered through a feed line 200 to an extrusion hopper 202 from a pressurized tank 204 by a pump 206. The dope is cast onto a highly polished metal drum 208 located within a first drying section 210 of the drying oven 212. The cast film 214 is allowed to partially dry on the moving drum 208 and is then peeled from the drum 208. The cast film 214 is then conveyed to a final drying section 216 to remove the remaining solvent. The final dried film 218 is then wound into rolls at a wind-up station 220. The prior art cast film typically has a thickness in the range of from 40 to 200 μm.

Coating methods are distinguished from casting methods by the process steps necessary for each technology. These process steps in turn affect a number of tangibles such as fluid viscosity, converting aids, substrates, and hardware that are unique to each method. In general, coating methods involve application of dilute low viscosity liquids to thin flexible substrates, evaporating the solvent in a drying oven, and winding the dried film/substrate composite into rolls. In contrast, casting methods involve applying a concentrated viscous dope to a highly polished metal drum or band, partially drying the wet film on the metal substrate, stripping the partially dried film from the substrate, removing additional solvent from the partially dried film in a drying oven, and winding the dried film into rolls. In terms of viscosity, coating methods require very low viscosity liquids of less than 5,000 cp. In the practice of the method of the present invention the viscosity of the coated liquids will generally be less than 2000 cp and most often less than 1500 cp. Moreover, in the method of the present invention the viscosity of the lowermost layer is preferred to be less than 200 cp. and most preferably less than 100 cp. for high speed coating application. In contrast, casting methods require highly concentrated dopes with viscosity on the order of 10,000-100,000 cp for practical operating speeds. In terms of converting aids, coating methods generally involve the use of surfactants as converting aids to control flow after coating artifacts such as mottle, repellencies, orange peel, and edge withdraw. In contrast, casting methods do not require surfactants. Instead, converting aids are only used to assist in the stripping and conveyance operations in casting methods. For example, lower alcohols are sometimes used as converting aids in cast optical films to minimize abrasion artifacts during conveyance through drying ovens. In terms of substrates, coating methods generally utilize thin (10-250 micron) flexible supports. In contrast, casting methods employ thick (1-100 mm), continuous, highly polished metal drums or rigid bands. As a result of these differences in process steps, the hardware used in coating is conspicuously different from those used in casting as can be seen by a comparison of the schematics shown in FIGS. 1 and 7, respectively.

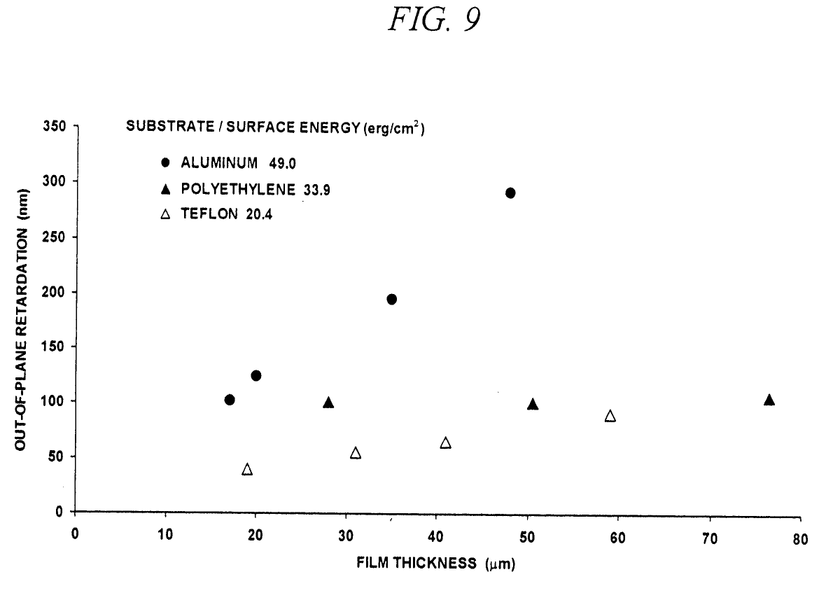

FIG. 9 shows the dependence of the out-of-plane retardation on film thickness for a polycarbonate resin film cast from a methylene chloride solution onto a variety of substrates with different surface energies. In-plane retardation for these polycarbonate films were all essentially equal to zero. Retardation and surface energy were determined as outlined below.

Retardation. Retardation of resin films were determined in nanometers (nm) using a Woollam M-2000V Spectroscopic Ellipsometer at wavelengths from 370 to 1000 nm. In-plane and out-of-plane retardation are defined by the formula:
Rₑ=|nₓ−n_{y}|×d
R_{OOP}=|[0.5(nₓ+n_{y})−n_{z}}]|×d
where Rₑ is the in-plane retardation at 590 nm, R_{OOP} (or OPR) is the out-of-plane retardation at 590 nm, nₓ is the index of refraction of the peeled film along the machine direction, n_{y} is the is the index of refraction of the peeled film along the transverse direction, n_{z} is the refractive index of the film parallel to its plane and d is the thickness of the peeled film in nanometers (nm). Thus, Rₑ is the absolute value of the difference in refractive index between the machine and transverse directions of the peeled film multiplied by the thickness of the film. Rₒₒₚ is similarly the difference between the average of the refractive indices in the machine and transverse directions and the refractive index parallel to the plane of the film multiplied by the the thickness of the film.

Surface Energy. The surface energy of a solid surface is determined using the Girifalco-Good-Fowkes equation. This equation requires the measurement of contact angles between the solid surface and a drop of liquid and the surface tension, dispersive force and polar force of the liquid. The measurements for this invention were made using distilled water (a polar liquid) and methylene iodide (a nonpolar liquid). The surface tension, dispersive forces and polar forces of the two liquids are listed in the table below

| | Surface Tension | Dispersive Force | Polar Force |
|---|---|---|---|
| Liquid | (erg/cm²) | (erg/cm²) | (erg/cm²) |
| Water | 72.8 | 21.8 | 51 |
| Methylene iodide | 50.8 | 48.5 | 2.3 |

The contact angle measurements were performed on clean surfaces at room temperature, 20 C, using a Rame-Hart Goniometer with a white light source. The surfaces were cleaned by repeated rinses with acetone, isopropanol and distilled water. A drop of distilled water or methylene iodide was placed on the clean surface and the contact angle was measured on each side of the drop, for 2-3 drops for each liquid.

In accordance with the invention, composite elements may be prepared that comprise a carrier substrate having a low surface energy, an optical resin film having an out-of-plane retardation of less than 100 nm and an in-plane retardation of less than 20 nm, and one or more auxiliary layers that are applied on the said optical resin film. The one or more auxiliary layers may be applied simultaneously with the optical resin film or they may be applied in a separate coating operation. Suitable auxiliary layers for use in the present invention include PVA adhesion-promoting layer, abrasion resistant hardcoat layer, antiglare layer, anti-smudge layer or stain-resistant layer, antireflection layer, low reflection layer, antistatic layer, viewing angle compensation layer, and moisture barrier layer. Optionally, the composite element of the invention may also comprise a strippable, protection layer on the side of the composite element opposite to the carrier substrate.

Particularly effective abrasion resistant layers for use in the present invention comprise radiation or thermally cured compositions, and preferably the composition is radiation cured. Ultraviolet (UV) radiation and electron beam radiation are the most commonly employed radiation curing methods. UV curable compositions are particularly useful for creating the abrasion resistant layer of this invention and may be cured using two major types of curing chemistries, free radical chemistry and cationic chemistry. Acrylate monomers (reactive diluents) and oligomers (reactive resins and lacquers) are the primary components of the free radical based formulations, giving the cured coating most of its physical characteristics. Photo-initiators are required to absorb the UV light energy, decompose to form free radicals, and attack the acrylate group C═C double bond to initiate polymerization. Cationic chemistry utilizes cycloaliphatic epoxy resins and vinyl ether monomers as the primary components. Photo-initiators absorb the UV light to form a Lewis acid, which attacks the epoxy ring initiating polymerization. By UV curing is meant ultraviolet curing and involves the use of UV radiation of wavelengths between 280 and 420 nm preferably between 320 and 410 nm.

Examples of UV radiation curable resins and lacquers usable for the abrasion layer useful in this invention are those derived from photo polymerizable monomers and oligomers such as acrylate and methacrylate oligomers (the term “(meth)acrylate” used herein refers to acrylate and methacrylate), of polyfunctional compounds, such as polyhydric alcohols and their derivatives having (meth)acrylate functional groups such as ethoxylated trimethylolpropane tri(meth)acrylate, tripropylene glycol di(meth)acrylate, trimethylolpropane tri(meth)acrylate, diethylene glycol di(meth)acrylate, pentaerythritol tetra(meth)acrylate, pentaerythritol tri(meth)acrylate, dipentaerythritol hexa(meth)acrylate, 1,6-hexanediol di(meth)acrylate, or neopentyl glycol di(meth)acrylate and mixtures thereof, and acrylate and methacrylate oligomers derived from low-molecular weight polyester resin, polyether resin, epoxy resin, polyurethane resin, alkyd resin, spiroacetal resin, epoxy acrylates, polybutadiene resin, and polythiol-polyene resin, and the like and mixtures thereof, and ionizing radiation-curable resins containing a relatively large amount of a reactive diluent. Reactive diluents usable herein include monofunctional monomers, such as ethyl (meth)acrylate, ethylhexyl (meth)acrylate, styrene, vinyltoluene, and N-vinylpyrrolidone, and polyfunctional monomers, for example, trimethylolpropane tri(meth)acrylate, hexanediol (meth)acrylate, tripropylene glycol di(meth)acrylate, diethylene glycol di(meth)acrylate, pentaerythritol tri(meth)acrylate, dipentaerythritol hexa(meth)acrylate, 1,6-hexanediol di(meth)acrylate, or neopentyl glycol di(meth)acrylate.

An example of a UV radiation curable resin that is conveniently used in the practice of this invention is CN 968® from Sartomer Company. The abrasion resistant layer of the invention typically provides a layer having a pencil hardness (using the Standard Test Method for Hardness by Pencil Test ASTM D3363) of at least 2H and preferably 2H to 8H.

The composite element of the invention may contain an antiglare layer, a low reflection layer or an antireflection layer. Such layers are employed in an LCD in order to improve the viewing characteristics of the display, particularly when it is viewed in bright ambient light.

An antiglare coating provides a roughened or textured surface that is used to reduce specular reflection. All of the unwanted reflected light is still present, but it is scattered rather than specularly reflected. For the purpose of the present invention, the antiglare coating preferably comprises a radiation cured composition that has a textured or roughened surface obtained by the addition of organic or inorganic (matting) particles or by embossing the surface. The radiation cured compositions described hereinabove for the abrasion resistant layer are also effectively employed in the antiglare layer. Surface roughness is preferably obtained by the addition of matting particles to the radiation cured composition. Suitable particles include inorganic compounds having an oxide, nitride, sulfide or halide of a metal, metal oxides being particularly preferred. As the metal atom, Na, K, Mg, Ca, Ba, Al, Zn, Fe, Cu, Ti, Sn, In, W, Y, Sb, Mn, Ga, V, Nb, Ta, Ag, Si, B, Bi, Mo, Ce, Cd, Be, Pb and Ni are suitable, and Mg, Ca, B and Si are more preferable. An inorganic compound containing two types of metal may also be used. A particularly preferable inorganic compound is silicon dioxide, namely silica.

Additional particles suitable for use in the antiglare layer of the present invention include the layered clays described in commonly-assigned U.S. patent application Ser. No. 10/690,123, filed Oct. 21, 2003. The most suitable layered particles include materials in the shape of plates with high aspect ratio, which is the ratio of a long direction to a short direction in an asymmetric particle. Preferred layered particles are natural clays, especially natural smectite clay such as montmorillonite, nontronite, beidellite, volkonskoite, hectorite, saponite, sauconite, sobockite, stevensite, svinfordite, halloysite, magadiite, kenyaite and vermiculite as well as layered double hydroxides or hydrotalcites. Most preferred clay materials include natural montmorillonite, hectorite and hydrotalcites, because of commercial availability of these materials.

Additional particles for use in the antiglare layer of the present invention include polymer matte particles or beads which are well known in the art. The polymer particles may be solid or porous, preferably they are crosslinked polymer particles. Porous polymer particles for use in an antiglare layer are described in commonly-assigned U.S. patent application Ser. No. 10/715,706, filed Nov. 18, 2003.

Particles for use in the antiglare layer have an average particle size ranging from 2 to 20 micrometers, preferably from 2 to 15 micrometers and most preferably from 4 to 10 micrometers. They are present in the layer in an amount of at least 2 wt percent and less than 50 percent, typically from about 2 to 40 wt. percent, preferably from 2 to 20 percent and most preferably from 2 to 10 percent.

The thickness of the antiglare layer is generally about 0.5 to 50 micrometers preferably 1 to 20 micrometers more preferably 2 to 10 micrometers.

Preferably, the antiglare layer used in the present invention has a 60° Gloss value, according to ASTM D523, of less than 100, preferably less than 90 and a transmission haze value, according to ASTM D-1003 and JIS K-7105 methods, of less than 50%, preferably less than 30%.

In another embodiment of the present invention, a low reflection layer or antireflection layer is used in combination with an abrasion resistant hard coat layer or antiglare layer. The low reflection or antireflection coating is applied on top of the abrasion resistant or antiglare layer. Typically, a low reflection layer provides an average specular reflectance (as measured by a spectrophotometer and averaged over the wavelength range of 450 to 650 nm) of less than 2%. Antireflection layers provide average specular reflectance values of less than 1%.

Suitable low reflection layers for use in the present invention comprise fluorine-containing homopolymers or copolymers having a refractive index of less than 1.48, preferably with a refractive index between about 1.35 and 1.40. Suitable fluorine-containing homopolymers and copolymers include: fluoro-olefins (for example, fluoroethylene, vinylidene fluoride, tetrafluoroethylene, hexafluoroethylene, hexafluoropropylene, perfluoro-2,2-dimethyl-1,3-dioxol), partially or completely fluorinated alkyl ester derivatives of (meth)acrylic acid, and completely or partially fluorinated vinyl ethers, and the like. The effectiveness of the layer may be improved by the incorporation of submicron-sized inorganic particles or polymer particles that induce interstitial air voids within the coating. This technique is further described in U.S. Pat. No. 6,210,858 and U.S. Pat. No. 5,919,555. Further improvement of the effectiveness of the low reflection layer may be realized with the restriction of air voids to the internal particle space of submicron-sized polymer particles with reduced coating haze penalty, as described in commonly-assigned U.S. patent application Ser. No. 10/715,655, filed Nov. 18, 2003.

The thickness of the low reflection layer is 0.01 to 1 micrometer and preferably 0.05 to 0.2 micrometer.

An antireflection layer may comprise a monolayer or a multi-layer. Antireflection layers comprising a monolayer typically provide reflectance values less than 1% at only a single wavelength (within the broader range of 450 to 650 nm). A commonly employed monolayer antireflection coating that is suitable for use in the present invention comprises a layer of a metal fluoride such as magnesium fluoride (MgF₂). The layer may be applied by well-known vacuum deposition technique or by a sol-gel technique. Typically, such a layer has an optical thickness (i.e., the product of refractive index of the layer times layer thickness) of approximately one quarter-wavelength at the wavelength where a reflectance minimum is desired.

Although a monolayer can effectively reduce the reflection of light within a very narrow wavelength range, more often a multi-layer comprising several (typically, metal oxide based) transparent layers superimposed on one another is used to reduce reflection over a wide wavelength region (i.e., broadband reflection control). For such a structure, half wavelength layers are alternated with quarter wavelength layers to improve performance. The multi-layer antireflection coating may comprise two, three, four, or even more layers. Formation of this multi-layer typically requires a complicated process comprising a number of vapor deposition procedures or sol-gel coatings, which correspond to the number of layers, each layer having a predetermined refractive index and thickness. Precise control of the thickness of each layer is required for these interference layers. The design of suitable multi-layer antireflection coatings for use in the present invention is well known in the patent art and technical literature, as well as being described in various textbooks, for example, in H. A. Macleod, “Thin Film Optical Filters,” Adam Hilger, Ltd., Bristol 1985 and James D. Rancourt, “Optical Thin Films User's Handbook”, Macmillan Publishing Company, 1987.

The composite elements of the invention may contain a moisture barrier layer comprising a hydrophobic polymer such as a vinylidene chloride polymer, vinylidene fluoride polymer, polyurethane, polyolefin, fluorinated polyolefin, polycarbonate, and others, having a low moisture permeability. Preferably, the hydrophobic polymer comprises vinylidene chloride. More preferably, the hydrophobic polymer comprises 70 to 99 weight percent of vinylidene chloride. The moisture barrier layer may be applied by application of an organic solvent-based or aqueous coating formulation. To provide effective moisture barrier properties the layer should be at least 1 micrometer in thickness, preferably from 1 to 10 micrometers in thickness, and most preferably from 2 to 8 micrometers in thickness. The moisture barrier layer has a moisture vapor transmission rate (MVTR) according to ASTM F-1249 that is less than 1000 g/m²/day, preferably less than 800 g/m²/day and most preferably less than 500 g/m²/day. The use of such a barrier layer on the optical resin films of the invention provides improved resistance of the optical film to changes in humidity.

The composite elements of the invention may contain a transparent antistatic layer that aids in the control of static charging that may occur during the manufacture and use of the composite element and optical film. The composite elements of the invention may be particularly prone to triboelectric charging during the peeling of the optical resin film from the carrier substrate. The so-called “separation charge” that results from the separation of the resin film and the substrate can be effectively controlled by an antistatic layer having a resistivity of less than about 1×10¹¹ Ω/square, preferably less than 1×10¹⁰ Ω/square, and most preferably less than 1×10⁹ Ω/square.

Conductive materials employed in the antistatic layer may be either ionically-conductive or electronically-conductive. Ionically-conductive materials include simple inorganic salts, alkali metal salts of surfactants, polymeric electrolytes containing alkali metal salts, and colloidal metal oxide sols (stabilized by metal salts). Of these, ionically-conductive polymers such as anionic alkali metal salts of styrene sulfonic acid copolymers and cationic quaternary ammonium polymers of U.S. Pat. No. 4,070,189 and ionically-conductive colloidal metal oxide sols which include silica, tin oxide, titania, antimony oxide, zirconium oxide, alumina-coated silica, alumina, boehmite, and smectite clays are preferred.

The antistatic layer employed in the current invention preferably contains an electronically-conductive material due to their humidity and temperature independent conductivity. Suitable materials include:
1) electronically-conductive metal-containing particles including donor-doped metal oxides, metal oxides containing oxygen deficiencies, and conductive nitrides, carbides, and bromides. Specific examples of particularly useful particles include conductive SnO₂, In₂O, ZnSb₂O₆, InSbO₄, TiB₂, ZrB₂, NbB₂, TaB₂, CrB, MoB, WB, LaB₆, ZrN, TiN, WC, HfC, HfN, and ZrC. Examples of the patents describing these electrically conductive particles include; U.S. Pat. Nos. 4,275,103; 4,394,441; 4,416,963; 4,418,141; 4,431,764; 4,495,276; 4,571,361; 4,999,276; 5,122,445; and 5,368,995.
2) fibrous electronic conductive particles comprising, for example, antimony-doped tin oxide coated onto non-conductive potassium titanate whiskers as described in U.S. Pat. Nos. 4,845,369 and 5,166,666, antimony-doped tin oxide fibers or whiskers as described in U.S. Pat. Nos. 5,719,016 and 5,0731,119, and the silver-doped vanadium pentoxide fibers described in U.S. Pat. No. 4,203,769
3) electronically-conductive polyacetylenes, polythiophenes, and polypyrroles, preferably the polyethylene dioxythiophene described in U.S. Pat. No. 5,370,981 and commercially available from Bayer Corp. as Baytron® P.

The amount of the conductive agent used in the antistatic layer of the invention can vary widely depending on the conductive agent employed. For example, useful amounts range from about 0.5 mg/M² to about 1000 mg/M², preferably from about 1 mg/m² to about 500 mg/m². The antistatic layer has a thickness of from 0.05 to 5 micrometers, preferably from 0.1 to 0.5 micrometers to insure high transparency.

Contrast, color reproduction, and stable gray scale intensities are important quality attributes for electronic displays, which employ liquid crystal technology. The primary factor limiting the contrast of a liquid crystal display is the propensity for light to “leak” through liquid crystal elements or cells, which are in the dark or “black” pixel state. Furthermore, the leakage and hence contrast of a liquid crystal display are also dependent on the direction from which the display screen is viewed. Typically the optimum contrast is observed only within a narrow viewing angle range centered about the normal incidence to the display and falls off rapidly as the viewing direction deviates from the display normal. In color displays, the leakage problem not only degrades the contrast but also causes color or hue shifts with an associated degradation of color reproduction.

Thus, one of the major factors measuring the quality of LCDs is the viewing angle characteristic, which describes a change in contrast ratio from different viewing angles. It is desirable to be able to see the same image from a wide variation in viewing angles and this ability has been a shortcoming with liquid crystal display devices. One way to improve the viewing angle characteristic is to employ an optical resin film having a viewing angle compensation layer (also referred to as a compensation layer, retarder layer, or phase difference layer), with proper optical properties, between the PVA-dichroic film and liquid crystal cell, such as disclosed in U.S. Pat. Nos. 5,583,679, 5,853,801, 5,619,352, 5,978,055, and 6,160,597. A compensation film according to U.S. Pat. Nos. 5,583,679 and 5,853,801 based on discotic liquid crystals which have negative birefringence, is widely used.

Viewing angle compensation layers useful in the present invention are optically anisotropic layers. The optically anisotropic, viewing angle compensation layers may comprise positively birefringent materials or negatively birefringent materials. The compensation layer may be optically uniaxial or optically biaxial. The compensation layer may have its optic axis tilted in the plane perpendicular to the layer. The tilt of the optic axis may be constant in the layer thickness direction or the tilt of the optic axis may vary in the layer thickness direction.

Optically anisotropic, viewing angle compensation layers useful in the present invention may comprise the negatively birefringent, discotic liquid crystals described in U.S. Pat. Nos. 5,583,679, and 5,853,801; the positively birefringent nematic liquid crystals described in U.S. Pat. No. 6,160,597; and the negatively birefringent amorphous polymers described in commonly-assigned U.S. patent application Publication No. 2004/0021814A and U.S. patent application Ser. No. 10/745,109, filed Dec. 23, 2003.

The auxiliary layers of the invention may also include the PVA adhesion-promoting layers described in commonly-assigned U.S. patent application Ser. No. 10/838,841 filed May 4, 2004.

The auxiliary layers of the invention can be applied by any of a number of well known liquid coating techniques, such as dip coating, rod coating, blade coating, air knife coating, gravure coating, microgravure coating, reverse roll coating, slot coating, extrusion coating, slide coating, curtain coating, or by vacuum deposition techniques. In the case of liquid coating, the wet layer is generally dried by simple evaporation, which may be accelerated by known techniques such as convection heating. The auxiliary layer may be applied simultaneously with the optical resin film or it may be applied after coating and drying of the optical resin film. Several different auxiliary layers may be coated simultaneously using slide coating, for example, an antistatic layer may be coated simultaneously with a moisture barrier layer or a moisture barrier layer may be coated simultaneously with a viewing angle compensation layer. Known coating and drying methods are described in further detail in Research Disclosure 308119, Published December 1989, pages 1007 to 1008.

The optical films of the invention are suitable for use with a wide variety of LCD display modes, for example, Twisted Nematic (TN), Super Twisted Nematic (STN), Optically Compensated Bend (OCB), In Plane Switching (IPS), or Vertically Aligned (VA) liquid crystal displays. These various liquid crystal display technologies have been reviewed in U.S. Pat. No. 5,619,352 (Koch et al.), U.S. Pat. No. 5,410,422 (Bos), and U.S. Pat. No. 4,701,028 (Clerc et al.).

As should be obvious based on the preceding detailed description, a wide variety of composite elements and optical films having various types and arrangements of auxiliary layers may be prepared. Some of the configurations possible in accordance with the present invention are illustrated by the following non-limiting examples.

Composite C1:

TAC
polyethylene
PET

A 100 micrometer thick polyethylene terephthalate (PET) substrate is corona treated and extrusion coated with a 25 micrometer thick polyethylene layer (polyethylene has a surface tension of 31 erg/cm² based on results reported in “Adhesion and Cohesion”, Philip Weiss ed., p 190, Elsevier Publishing Company, Amsterdam, 1962). A triacetyl cellulose (TAC) coating formulation is applied from methylene chloride solution onto the polyethylene surface. The dried TAC film is 20 micrometers in thickness and contains 11 wt % triphenyl phosphate plasticizer, 1 wt % TINUVIN® 8515 UV absorber (a mixture of 2-(2′-Hydroxy-3′-tert-butyl-5′-methylphenyl)-5-chloro benzotriazole and 2-(2′-Hydroxy-3′,5′-ditert-butylphenyl)-benzotriazole, available from Ciba Specialty Chemicals.) and 0.1 wt % PARSOL® 1789 UV absorber (4-(1,1-dimethylethyl)-4′-methoxydibenzoylmethane, available from Roche Vitamins Inc.).

Composite C2:

abrasion resistant layer
TAC
polyethylene
PET

Composite C2 is prepared in an analogous manner to composite C1 except an abrasion resistant layer, prepared by coating, drying and then UV curing a urethane acrylate oligomer, CN 968® from Sartomer Company, is applied onto the dried TAC film.

Composite C3:

low reflection layer
abrasion resistant layer
TAC
polyethylene
PET

Composite C3 is prepared in an analogous manner to composite C2 except a low reflection layer having a thickness of 0.1 micrometers, comprising a fluorinated olefin polymer is applied onto the abrasion resistant layer.

Composite C4:

low reflection layer
abrasion resistant layer
TAC
polystyrene
PET

Composite C4 is prepared in an analogous manner to composite C3 except the polyethylene terephthalate substrate has aa 0.5 micrometer thick polystyrene layer rather than a polyethylene layer. (Polystyrene has a surface tension of 33 erg/cm² based on results reported in “Adhesion and Cohesion”, Philip Weiss ed., p 190, Elsevier Publishing Company, Amsterdam, 1962).

Composite C5:

abrasion resistant layer
antistatic layer
moisture barrier layer
TAC
polyethylene
PET

Composite C5 is prepared in an analogous manner to composite C1 except that a 5 micrometer thick moisture barrier layer comprising poly(vinylidene chloride-co-acrylonitrile-co-acrylic acid) containing 78 wt % vinylidene chloride is applied onto the TAC layer. An antistatic layer comprising Baytron® P (polyethylene dioxythiophene/polystyrene sulfonate, available from Bayer Corp) in a poly(vinylidene chloride-co-acrylonitrile-co-acrylic acid) binder is applied onto the moisture barrier layer. The antistatic layer contains 3 mg/m² Baytron® P and has a surface resistivity of about 1×10⁸ Ω/square. The abrasion resistant layer employed in composite C1 is applied onto the antistatic layer.

Composite C6:

abrasion resistant layer
antistatic layer
moisture barrier layer
polycarbonate
polyethylene
PET

Composite C6 is prepared in an analogous manner to composite C5 except that a 20 micrometer thick layer of a polycarbonate, Bisphenol A type homopolymer, is used in place of TAC as the low birefringence polymer film.

Guarded cover sheet composite C7:

TAC
polyethylene substrate

Guarded cover sheet composite C7 is prepared in an analogous manner to composite C1 except that in place of a PET substrate having a polyethylene extrusion coated layer, the carrier substrate is a 100 micron thick polyethylene film.

The invention has been described in detail with particular reference to certain preferred embodiments thereof, but it will be understood that variations and modifications can be effected within the spirit and scope of the invention.

From the foregoing, it will be seen that this invention is one well adapted to obtain all of the ends and objects hereinabove set forth together with other advantages which are apparent and which are inherent to the apparatus.

It will be understood that certain features and subcombinations are of utility and may be employed with reference to other features and subcombinations. This is contemplated by and is within the scope of the claims.

As many possible embodiments may be made of the invention without departing from the scope thereof, it is to be understood that all matter herein set forth and shown in the accompanying drawings is to be interpreted as illustrative and not in a limiting sense. The entire contents of the patents and other publications referred to in this specification are incorporated herein by reference.

### Parts List

10 drying system 66 drying section
12 moving substrate/web 68 drying section
14 dryer 70 drying section
16 coating apparatus 72 drying section
18 unwinding station 74 drying section
20 back-up roller 76 drying section
22 coated web 78 drying section
24 dry film 80 drying section
26 wind up station 82 drying section
28 coating supply vessel 92 front section
30 coating supply vessel 94 second section
32 coating supply vessel 96 third section
34 coating supply vessel 98 fourth section
36 pumps 100 back plate
38 pumps 102 inlet
40 pumps 104 metering slot
42 pumps 106 pump
44 conduits 108 lower most layer
46 conduits 110 inlet
48 conduits 112 2^{nd} metering slot
50 conduits 114 pump
52 discharge device 116 layer
54 polar charge assist device 118 inlet
56 opposing rollers 120 metering slot
58 opposing rollers 122 pump
60 resin film 124 layer
62 winding station 126 inlet
64 winding station 128 metering slot
130 pump 208 metal drum
132 layer 210 drying section
136 coating lip 212 drying oven
214 coating layer
138 2^{nd} incline slide surface 216 final drying section
140 3^{rd} incline slide surface 218 final dried film
142 4^{th} incline slide surface 220 wind-up station
144 back land surface
146 coating bead
150 resin film
152 carrier substrate
154 carrier substrate
156 coated surface layer
158 resin film
160 multiple layer film
162 lowermost layer
164 intermediate layers
166 intermediate layers
168 upper most layer
170 carrier support
172 composite film
174 lower most layer
176 intermediate layers
178 intermediate layers
180 upper most layers
182 carrier substrate
184 coated surface layer
200 feed line
202 extrusion hopper
204 pressurized tank
206 pump

1. A process for forming an optical resin film, having an out-of-plane retardation (OPR) of less than 100 nm, comprising the steps of:
(a) applying a liquid optical resin /solvent mixture onto the surface of a moving discontinuous carrier substrate having a surface energy level less than 35 erg/cm²;
(b) drying the liquid resin/solvent mixture to substantially remove the solvent yielding a composite of a resin film weakly adhered to the carrier substrate, the resin film being releasably adhered to the carrier substrate thereby allowing the resin film to be peeled from the carrier substrate, and
(c) removing the film from the substrate, with the formed film exhibiting OPR of less than 100 nm, and in plane retardation of less than 20 nm.

2. A process as recited in claim 1 wherein:
the liquid resin/solvent mixture is applied onto a discontinuous carrier substrate having a length of 1 Om or more.

3. A process as recited in claim 1 wherein: the liquid resin/solvent mixture is applied using a roll-to-roll process.

4. A process as recited in claim 1 wherein: the liquid resin/solvent mixture is applied using slide bead coating die with a multilayer composite being formed on a slide surface thereof.

5. A process as recited in claim 2 wherein: the viscosity of each liquid layer of the multilayer composite is less than 5000 cp.

6. A process as recited in claim 1 wherein: the carrier substrate is polyethylene terephthalate.

7. A process as recited in claim 1 wherein: the carrier substrate has a surface layer applied to the coated surface and the surface energy of said layer is less than 35 erg/cm².

8. A process as recited in claim 2 wherein:
an uppermost layer of the multilayer composite contains a surfactant.

9. A process as recited in claim 2 wherein:
at least a top layer of the multilayer composite contains a polysiloxane surfactant.

10. A process as recited in claim 1 further comprising the step of:
winding the composite into at least one roll before the optical resin film is peeled from the discontinuous carrier substrate.

11. A process as recited in claim 1 further comprising the steps of:
(a) separating the resin film from the carrier substrate immediately after the drying step; and
(b) winding the optical resin film into at least one roll.

12. The process of claim 8 further comprising the step of:
unwinding at least a portion of at least one roll of the composite; and
separating the resin film from the carrier substrate.

13. The process of claim 1 wherein said optical resin comprises cellulose ester and out of plane retardation is less than 20 nm.

14. A process as recited in claim 1 wherein:
the resin film is adhered to the carrier substrate with an adhesive strength of less than about 250 N/m.

15. A process as recited in claim 11 further comprising the step of:
reducing residual solvent in the optical resin film to less than 10% by weight prior to the separating step.

16. A process as recited in claim 12 further comprising the step of:
reducing residual solvent in the optical resin film to less than 10% by weight prior to the separating step.

17. A process as recited in claim 2 wherein:
at least a top layer of the multilayer composite contains a fluorinated surfactant.

18. A process as recited in claim 1 wherein:
the resin film has an in-plane retardation of less than 10 nm and an OPR of less than 10 nm.

19. A process as recited in claim 1 wherein:
the resin film has an in-plane retardation of between 0.5 and 5 nm and an OPR of between 0.5 and 5 nm.

20. A process as recited in claim 1 further comprising the step of:
applying at least one additional resin layer to the composite after the drying step.

21. A process as recited in claim 1 wherein: the resin film has a thickness in the range of 1 to 100 μm.

22. The process of claim 1 wherein said film comprises resin selected from the group consisting of polycarbonates, polyesters, cellulosics, polyolefins, acrylics, styrenics, polyamides and polyester amides.

23. The process of claim 1 wherein said discontinuous carrier substrate has a coating surface comprising a fluorinated polymer.

24. The process of claim 1 wherein said discontinuous carrier substrate has a coating surface comprising a polyolefin.

25. The process of claim 1 wherein said discontinuous carrier substrate has a coating surface comprising a silicon-based polymer.

26. The process of claim 1 wherein said optical resin comprises triacetyl cellulose.

27. The process of claim 1 wherein said optical resin film includes one or more UV absorbers.

28. A composite element comprising:
a resin film coated on a discontinuous carrier substrate, the resin film having a thickness in the range of from 1 to 100 μm, the resin film having an in-plane retardation that is less than 20 nm and an OPR less than 20 nm, the resin film being adhered to the carrier substrate with an adhesive strength of less than about 250 N/m.

29. A composite element as recited in claim 28 wherein:
the resin film has an in-plane retardation that is less than 10 nm and an OPR less than 10 nm.

30. A composite element as recited in claim 28 wherein:
the resin film has an in-plane retardation that is between 0.5 and 5 nm and an OPR of between 0.5 and 5 nm.

31. A composite element as recited in claim 28 wherein:
the resin film is adhered to the carrier substrate with an adhesive strength of at least about 0.3 N/m.

32. A composite element as recited in claim 28 wherein:
the resin film is peelable from the carrier substrate.

33. A composite element as recited in claim 28 wherein: the resin film is a multilayer composite.

34. A composite element as recited in claim 33 wherein: at least a top layer of the multilayer composite includes a surfactant therein.

35. A composite element as recited in claim 28 wherein: a plasticizer is incorporated in the optical resin film.

36. A composite element as recited in claim 28 wherein: one or more UV absorbers are incorporated in the optical resin film.

37. The composite element of claim 28 wherein the resin film comprises cellulose ester.

38. A composite element comprising:
a polycarbonate resin film at least 10 meters in length coated on a discontinuous carrier substrate, the resin film having a thickness in the range of from 1 to 100 μm, the resin film having an in-plane retardation that is less than 20 nm and an out of plane retardation less than 100 nm, the resin film being adhered to the carrier substrate with an adhesive strength of less than about 250 N/m.

39. A composite element as recited in claim 38 wherein:
the resin film has an in-plane retardation that is between 0.5 and 5 nm and an out of plane retardation of less than 80 nm.

40. A composite element as recited in claim 38 wherein:
the resin film is adhered to the carrier substrate with an adhesive strength of at least about 0.3 N/m.

41. A composite element as recited in claim 38 wherein:
the resin film is peelable from the carrier substrate.

42. A composite element as recited in claim 38 wherein:
the resin film is a multilayer composite.

43. A composite element as recited in claim 38 wherein:
at least a top layer of the multilayer composite includes a surfactant therein.

44. A composite element as recited in claim 38 wherein:
a plasticizer is incorporated in the optical resin film.

45. A composite element as recited in claim 38 wherein: one or more UV absorbers are incorporated into the optical resin film.

46. A resin film comprising:
a layer of resin formed by a coating operation, the resin film having a thickness in the range of from 1 to 100 μm, the resin film having an in-plane retardation that is less than 20 nm and an out-of-plane retardation of less than 20 nm.

47. A resin film as recited in claim 46 wherein:
the optical resin film having an in-plane retardation that is less than 10 nm and an out-of-plane retardation less than 10 nm.

48. A resin film as recited in claim 46 wherein:
the resin film having an in-plane retardation that is between 0.5 and 5 nm and an out-of-plane retardation of between 0.5 and 5 nm.

49. A liquid crystal display comprising a resin film comprising:
a layer of resin formed by a coating operation, the resin film having a thickness in the range of from 1 to 100 μm, the resin film having an in-plane retardation that is less than 20 nm and an out-of-plane retardation of less than 20 nm.

50. A liquid crystal display comprising as recited in claim 49 wherein:
the resin film has an in-plane retardation that is less than 10 nm and an OPR less than 10 nm.

51. A liquid crystal display comprising as recited in claim 49 wherein:
the resin film has an in-plane retardation that is between 0.5 and 5 nm and an OPR of between 0.5 and 5 nm.

52. A composite film as recited in claim 49 wherein:
at least a top layer of the multilayer composite includes a fluorinated surfactant therein.

53. A liquid crystal display comprising a resin film comprising:
a layer of polycarbonate resin formed by a coating operation, the resin film having a thickness in the range of from 5 to 100 μm, the resin film having an in-plane retardation that is less than 20 nm and an out-of-plane retardation of less than 100 nm.

54. A liquid crystal display comprising as recited in claim 53 wherein:
the resin film has an in-plane retardation that is less than 10 nm and an OPR less than 80 nm.

55. A composite film as recited in claim 54 wherein:
at least a top layer of the multilayer composite includes a fluorinated surfactant therein.
